(19) United States
(12) Patent Application Publication
(10) Pub. No.: US 2008/0224990 A1
(43) Pub. Date: Sep. 18, 2008

(54) ACTIVE MATRIX CIRCUIT SUBSTRATE AND DISPLAY DEVICE

(75) Inventor: Yasuhiro SHIMODAIRA, Fujimi (JP)

Correspondence Address: HARNESS, DICKEY & PIERCE, P.L.C., P.O. BOX 828, BLOOMFIELD HILLS, MI, 48303, US

(73) Assignee: SEIKO EPSON CORPORATION, Tokyo (JP)

(21) Appl. No.: 12/035,728

(22) Filed: Feb. 22, 2008

(30) Foreign Application Priority Data
Mar. 8, 2007 (JP) 2007-059018

(51) Int. Cl. G02F 1/167; G09G 3/34

(52) U.S. Cl. 345/107; 345/55

(57) ABSTRACT

Provided is an active matrix circuit substrate including: a substrate on which a plurality of pixels are formed in a predetermined region; a plurality of pixel electrodes which are respectively provided in the pixels formed on the substrate and include peripheral pixel electrodes which protrude from the predetermined region to an outer region of the predetermined region; and pixel driving circuits which are provided in the predetermined region of the substrate in correspondence with the pixel electrodes and supply driving signals to the pixel electrodes.

### BACKGROUND

1. Technical Field

The present invention relates to an active matrix circuit substrate and a display device including the active matrix circuit substrate.

2. Related Art

In a display unit of an electronic apparatus such as a mobile telephone or a wristwatch, a display device for displaying a still image or a moving image is mounted. As such a display device, for example, an electrophoretic display device has a configuration in which an electrophoretic layer is interposed between a pair of substrates (a first substrate and a second substrate) which face each other. In a display region of the electrophoretic display device, a plurality of pixels are arranged in a matrix in plan view. In the electrophoretic display device, for example, pixel electrodes are provided on a surface of the first substrate opposite to the second substrate in every pixel. Opposing electrodes are provided on an entire surface of the second substrate opposite to the first substrate. A predetermined electric field is applied between the pixel electrodes and the opposing electrodes so as to drive the electrophoretic layer interposed between the both substrates.

On a lower layer side (a first substrate surface side) of the pixel electrodes on the first substrate, pixel driving circuits for applying driving signals to the pixel electrodes are formed. In general, the pixel driving circuits are formed so as to overlap the pixel electrodes in plan view. In the peripheral region of the display region of the electrophoretic display device, a driver circuit for supplying predetermined electric signals to the pixel driving circuits is formed. Since wires for the driver circuit are finely formed in the region in which the driver circuit is formed, the pixel driving circuits cannot be formed in the region in which the driver circuit is formed. Accordingly, in the related art, the pixel electrodes are not formed in the driver formation region and the display region of the electrophoretic display device is restricted to a region excluding the driver formation region. Since the driver formation region which does not perform display is shielded by a light shielding unit, the peripheral portion of the electrophoretic display device appears dark.

From the viewpoint of design and flexibility, recently, an electrophoretic display device in which a portion which appears dark is reduced and a display region is increased is required. For example, JP-A-2006-227053 suggests a method of segment-driving the driver formation region and expanding the display region to a driver formation region.

However, since the method disclosed in JP-A-2006-227053 is the segment-driving method, a freedom degree of the display of the driver formation region is less than that of the display of the display region. In this configuration, since a connection terminal needs to be separately provided or a segment control circuit needs to be separately provided in order to improve the freedom degree of the display of the driver formation region, the design of a driving system becomes complicated.

### SUMMARY

An advantage of some aspects of the invention is that it provides an active matrix driving display device which has a wider display region and in which the design of a driving system is not complicated while maintaining a high freedom degree of display, and an active matrix circuit substrate which is used as a component of the active matrix driving display device.

According to an aspect of the invention, there is provided an active matrix circuit substrate including: a substrate on which a plurality of pixels are formed in a predetermined region; a plurality of pixel electrodes which are respectively provided in the pixels formed on the substrate and include peripheral pixel electrodes which protrude from the predetermined region to an outer region of the predetermined region; and pixel driving circuits which are provided in the predetermined region of the substrate in correspondence with the pixel electrodes and supply driving signals to the pixel electrodes.

According to the invention, since the plurality of pixel electrodes provided on the substrate include the peripheral pixel electrodes which are provided so as to protrude from the predetermined region to the outer region of the predetermined region, it is possible to perform a display even in the outside of the predetermined region, in which the peripheral pixel electrodes are arranged. Accordingly, a display region includes the outer region of the predetermined region as well as the predetermined region in which the pixels are provided. According to this configuration, since the driving signals are supplied from the pixel driving circuits to the peripheral pixel electrodes similar to other pixel electrodes, it is possible to perform active matrix driving. Accordingly, it is possible to obtain an active matrix circuit substrate which has a wider display region and in which the design of a driving system is not complicated while maintaining a high freedom degree of display.

The active matrix circuit substrate may further include a driver circuit which is provided in the outer region of the predetermined region of the substrate and supplies electrical signals to the pixel driving circuits, and portions of the peripheral pixel electrodes may overlap the driver circuit in plan view.

According to the invention, since the driver circuit which supplies the electrical signals to the pixel driving circuits is provided in the outer region of the predetermined region of the substrate and the portions of the peripheral pixel electrodes overlap the driver circuit in plan view, the display region can widen to the region in which the driver circuit is provided.

In the active matrix circuit substrate, the area of each of the peripheral pixel electrodes may be larger than that of each of the pixel electrodes provided in the predetermined region.

According to the invention, since the area of each of the peripheral pixel electrodes is larger than that of each of the pixel electrodes provided in the predetermined region, it is possible to make a display of the outside of the predetermined region stand out.

In the active matrix circuit substrate, the pixel driving circuits may supply the driving signals each having an intensity according to the area of each of the pixel electrodes.

According to the invention, since the pixel driving circuits supply the driving signals each having an intensity according to the area of each of the pixel electrodes, it is possible to suppress unevenness in display due to a difference between the areas of the pixel electrodes and realize a stable and uniform display.

In the active matrix circuit substrate, the plurality of pixel driving circuits may be provided in each of the peripheral pixel electrodes.

According to the invention, since the plurality of pixel driving circuits are provided in each of the peripheral pixel electrodes, the pixel driving circuits can function as a redundancy circuit even when the pixel driving circuit is damaged. Accordingly, it is possible to perform a display with certainty.

In the active matrix circuit substrate, the plurality of peripheral pixel electrodes may be provided and some of the plurality of peripheral pixel electrodes may be ground electrodes.

According to the invention, since the plurality of peripheral pixel electrodes are provided and some of the plurality of peripheral pixel electrodes are ground electrodes, a constant voltage is always applied between the peripheral pixel electrodes and the opposing electrodes. If the peripheral pixel electrodes are formed of metal, an electrical resistance value is decreased and thus the peripheral pixel electrodes are used as reinforcement members of other wires. Since the other wires are reinforced by the peripheral pixel electrodes, the other wires can be thinly formed.

In the active matrix circuit substrate, the plurality of peripheral pixel electrodes may be provided and some of the plurality of peripheral pixel electrodes may be segment driving electrodes.

According to the invention, since the plurality of peripheral pixel electrodes are provided and some of the plurality of peripheral pixel electrodes are segment driving electrodes, it is possible to drive the peripheral pixel electrodes independent of the driving of the pixel driving circuits. Accordingly, it is possible to more increase the freedom degree of the display.

In the active matrix circuit substrate, a driving circuit for independently driving the segment driving electrodes may be provided.

According to the invention, since the driving circuit for independently driving the segment driving electrodes is provided, it is possible to perform a display by the driving circuit, that is, a driving system different from that of other pixel electrodes. Accordingly, it is possible to more increase the freedom degree of the display.

According to another aspect of the invention, there is provided a display device including first and second substrates which face each other with an electrophoretic material layer interposed therebetween; pixel electrodes which are formed on a surface of the first substrate opposite to the second substrate; and opposing electrodes which are formed on a surface of the second substrate opposite to the first substrate, wherein the first substrate is the active matrix circuit substrate.

According to the invention, since the active matrix circuit substrate which has a wider display region and in which the design of a driving system is not complicated while maintaining a high freedom degree of display is mounted, it is possible to obtain an active matrix driving display device having a large display area.

In the display device, the electrophoretic material may be an electrophoretic dispersion which is composed of electrophoretic particles and a liquid phase dispersion medium which disperses the electrophoretic particles.

According to the invention, since the electrophoretic element configuring the display device has a display retention property (a memory property), although an electric field applied to the electrophoretic particles is eliminated when the display is fixed, the display is held in a previous state due to the electric field. Accordingly, it is possible to reduce power consumption.

### BRIEF DESCRIPTION OF THE DRAWINGS

The invention will be described with reference to the accompanying drawings, wherein like numbers reference like elements.

FIG. 1 is a cross-sectional view showing the configuration of a display device according to a first embodiment of the invention.

FIG. 2 is a cross-sectional view showing an operation of the display device according to the present embodiment.

FIG. 3 is a plan view showing the configuration of the display device according to the present embodiment.

FIG. 4 is a view showing the configuration of a pixel of the display device according to the present embodiment.

FIG. 5 is a plan view showing the configuration of the display device according to the present embodiment.

FIG. 6 is a plan view showing the configuration of a portion of the display device according to the present embodiment.

FIG. 7 is a cross-sectional view showing the configuration of a portion of the display device according to the present embodiment.

FIG. 8 is a plan view showing the configuration of a portion of the display device according to the present embodiment.

FIG. 9 is a plan view showing the configuration of a first substrate of a display device according to a second embodiment of the invention.

FIG. 10 is a plan view showing the configuration of another display device according to the present embodiment.

FIG. 11 is a plan view showing the configuration of a first substrate of a display device according to a third embodiment of the invention.

FIG. 12 is a plan view showing the other configuration of the display device according to the present embodiment.

FIG. 13 is a plan view showing the other configuration of the display device according to the present embodiment.

FIG. 14 is a plan view showing the configuration of a wristwatch according to a fourth embodiment of the invention.

FIG. 15 is a cross-sectional view showing the configuration of the wristwatch according to the present embodiment.

FIG. 16 is a cross-sectional view showing the configuration of a display panel according to the present embodiment.

FIG. 17 is a plan view showing the configuration of a first substrate of the display panel according to the present embodiment.

### DESCRIPTION OF EXEMPLARY EMBODIMENTS

### First Embodiment

Hereinafter, a first embodiment of the invention will be described with reference to the accompanying drawings.

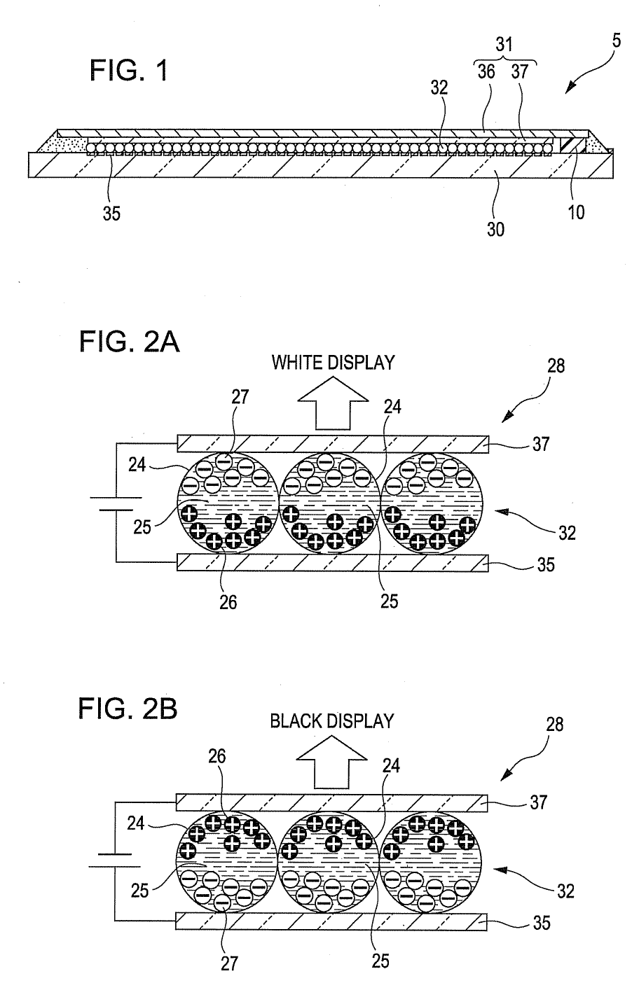

FIG. 1 is a cross-sectional view showing the configuration of a display device 5 according to the present embodiment.

As shown in FIG. 1, the display device 5 mainly includes a first substrate (active matrix circuit substrate) 30, a second substrate 31, and an electrophoretic layer 32.

The first substrate 30 and the second substrate 31 face each other with the electrophoretic layer 32 interposed therebetween. On an inner surface (opposite to the second substrate 31) of the first substrate 30, pixel electrodes 35 formed of a conductive material such as metal or indium tin oxide (ITO) are provided in every pixel. On an inner surface (opposite to the first substrate 30) of the second substrate 31, a common electrode (opposing electrode) 37 formed of a transparent conductive material such as ITO is formed. An outer surface of the second substrate 31 becomes a display surface for displaying an image such as a still image or a moving image.

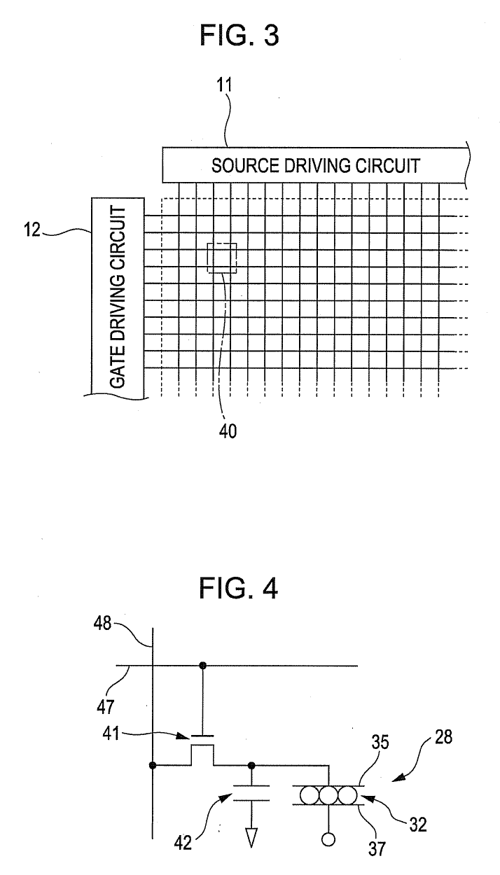

As shown in FIG. 3, in the display device 5, pixel units 40 are arranged in a matrix in plan view. As shown in FIG. 4, each of the pixel units 40 includes a transistor 41 functioning as a switching element, a holding capacitor 42 and an electrophoretic element 28. A pixel driving circuit 34 is configured by the transistor 41 and the holding capacitor 42.

The transistor 41 is, for example, a field effect n-channel transistor of which a gate is connected to a scan line 47, any one of a source and a drain (input terminal) is connected to a data line (signal line) 48, and the other of the source and the drain (output terminal) is connected to the pixel electrode 35 and the holding capacitor 42.

As shown in FIGS. 2A and 2B, the electrophoretic layer 32 is composed of a plurality of microcapsules 24 and electrophoretic dispersion 25 is sealed in each microcapsule 24. The electrophoretic dispersion 25 is an electrooptic material in the invention, in which a plurality of black electrophoretic particles (hereinafter, referred to as black particles) 26 charged with a positive polarity and a plurality of white electrophoretic particles (hereinafter, referred to as white particles) 27 charged with a negative polarity are dispersed in a liquid phase dispersion medium (not shown).

The operation of the electrophoretic element 28 composed of the pixel electrode 35, the common electrode 37 and the electrophoretic layer 32 (microcapsules 24) interposed between the electrodes will be described. As shown in FIG. 2A, if the voltage of the common electrode 37 is higher than that of the pixel electrode 35, the white particles 27 charged with the negative polarity are moved to the common electrode 37 and the black particles 26 charged with the positive polarity are moved to the pixel electrode 35. When viewing the common electrode 37, which becomes the display surface side, in this state, a white color is displayed in the pixel unit corresponding to the electrophoretic element 28.

As shown in FIG. 2B, if the voltage of the pixel electrode 35 is higher than that of the common electrode 37, the black particles 26 charged with the positive polarity are moved to the common electrode 37 and the white particles 27 charged with the negative polarity are moved to the pixel electrode 35. When viewing the common electrode 37 in this state, a black color is displayed in the pixel unit corresponding to the electrophoretic element 28. Accordingly, the white or black color is displayed in each pixel unit. In the display device 5 in which the pixel units are arranged in the matrix, a white or black pattern display is possible.

The electrophoretic dispersion 25 is not limited to the above-described two-particle system and a one-particle system may be used. In this case, a colored liquid phase dispersion medium may be used. In either the two-particle system or the one-particle system, with respect to the color of the particles, various colors may be used instead of the white color and the black color.

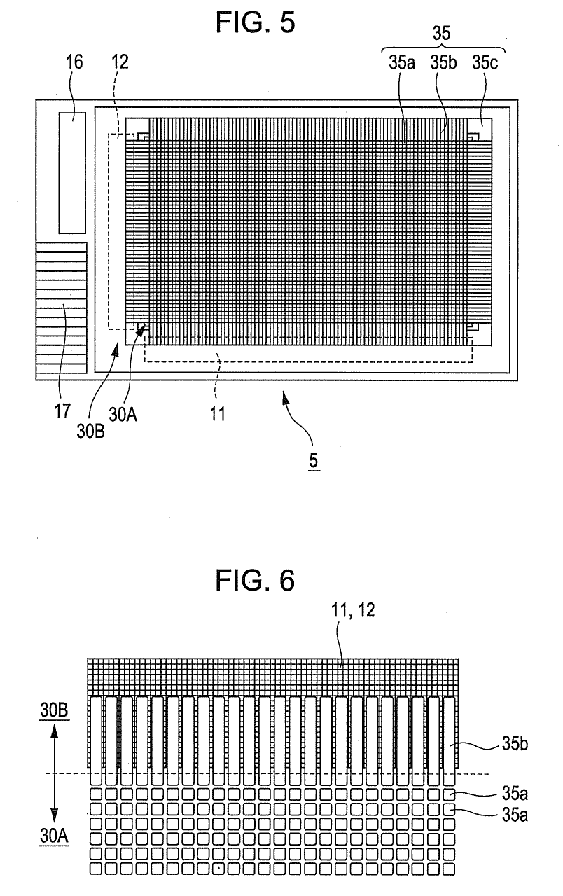

FIG. 5 is a plan view showing the configuration of the first substrate 30 functioning as the active matrix circuit substrate in the display device 5.

As shown in FIG. 5, hereinafter, it is assumed that a central portion of the first substrate 30 is a central region (a predetermined region) 30A and an outer region of the central region 30A is a peripheral region 30B. In the central region 30A of the first substrate 30, the pixels 40 are arranged in the matrix. In the peripheral region 30B of the first substrate 30, a source driving circuit 11 and a gate driving circuit 12 are provided. The source driving circuit 11 and the gate driving circuit 12 are driver circuits for supplying an electrical signal to the pixel driving circuit 34.

The pixel electrodes 35 include central pixel electrodes 35a, peripheral pixel electrodes 35b, and corner pixel electrodes 35c. The central pixel electrodes 35a are provided so as to overlap the pixels 40 of the central region 30A in plan view and are arranged in the matrix similar to the pixels 40. The central pixel electrodes 35a have a rectangular shape in plan view and the lengths of four sides thereof are substantially equal to one another.

The peripheral pixel electrodes 35b are provided at the outermost circumference of the central pixel electrodes 35a arranged in the matrix. The peripheral pixel electrodes 35b are arranged along the sides of the central region 30A and extend so as to protrude from the inside of the central region 30A to the outside (the peripheral region 30B) of the central region 30A.

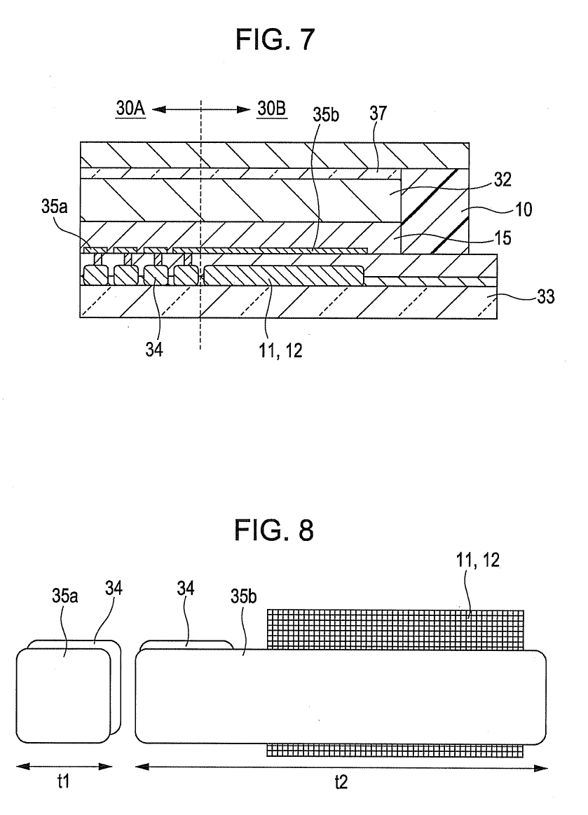

FIG. 6 is an enlarged view showing a portion of the first substrate 30. FIG. 7 is a cross-sectional view showing the configuration of the portion shown in FIG. 6 in the display device 5. As shown in FIGS. 6 and 7, portions of the peripheral pixel electrodes 35b are provided in the central region 30A. The portions of the peripheral pixel electrodes provided in the central region 30A are connected to the pixel driving circuit 34 and the peripheral pixel electrodes 35b are active matrix driven. Portions of the peripheral pixel electrodes 35b protruding to the peripheral region 30B extend so as to overlap the source driving circuit 11 or the gate driving circuit 12 provided in the peripheral region 30B in plan view. As shown in FIG. 8, the longitudinal dimension t2 of the peripheral pixel electrode 35b is four times the dimension t1 of one side of the central pixel electrode 35a. Since the area of the peripheral pixel electrode 35b is larger than that of the central pixel electrode 35a, the transistor 41 or the holding capacitor 42 of the pixel driving circuit 34 connected to the peripheral pixel electrode 35b makes the driving signal supplied to the peripheral pixel electrode 35b strong.

The corner pixel electrodes 35C are provided in the corners of the peripheral pixel electrodes 35b. The corner pixel electrodes 35c are provided so as to protrude from the corners of the central region 30A to the outside of the central region 30A. The region in which the central pixel electrodes 35a, the peripheral pixel electrodes 35b and the corner pixel electrodes 35c are arranged becomes the display region of the display device 5.

According to the present embodiment, since the plurality of pixel electrodes 35 provided on the first substrate 30 include the peripheral pixel electrodes 35b protruding from the central region 30A to the peripheral region 30B, the display is possible even in the peripheral region 30B in which the peripheral pixel electrodes 35b are arranged. Accordingly, the display region includes the peripheral region 30B as well as the central region 30A in which the pixels are provided. By this configuration, since the driving signals are supplied from the pixel driving circuits 34 to the peripheral pixel electrodes 35b similar to the pixel electrodes 35a, the peripheral pixel electrodes 35b are active matrix driven. Accordingly, it is possible to obtain an active matrix circuit substrate which has a wider display region and in which the design of a driving system is not complicated while maintaining a high freedom degree of display.

According to the present embodiment, since the area of the peripheral pixel electrode 35b is larger than that of the central pixel electrode 35a provided in the central region 30A, it is possible to make the display of the peripheral region 30B stand out. In addition, since the pixel driving circuits 34 of the first substrate 30 supply the driving signals having the intensities according to the areas of the pixel electrodes 35, it is possible to suppress unevenness in display due to a difference between the areas of the pixel electrodes 35 and realize a stable and uniform display.

### Second Embodiment

Next, a second embodiment of the invention will be described.

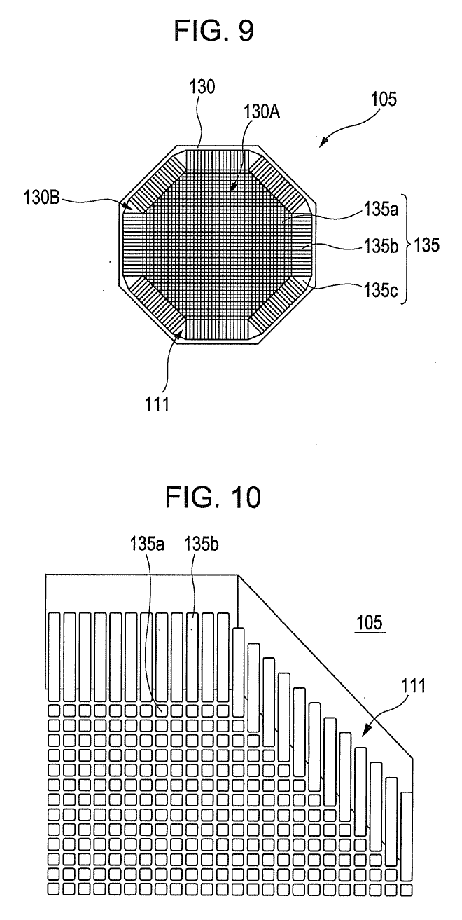

FIG. 9 is a view showing the configuration of a first substrate (active matrix circuit substrate) 130 of a display device 105 according to the present embodiment.

As shown in FIG. 9, the first substrate 130 of the display device 105 has an octagonal shape in plan view. A central portion of the first substrate 130 is a region (a central region 130A) in which pixels are arranged in a matrix. A peripheral portion of the first substrate 130 is, for example, a region (a peripheral region 130B) in which driver circuits are formed.

Pixel electrodes 135 are formed on a surface of the first substrate 130. The pixel electrodes 135 include three type of electrodes including central pixel electrodes 135a, peripheral pixel electrodes 135b and corner pixel electrodes 135c.

The central pixel electrodes 135a are rectangular pixel electrodes which are arranged in the central region 130a in a matrix in plan view. The central pixel electrodes are arranged along the shape (octagonal shape) of the central region 130A. In a region along a side inclined at 45° with respect to a row direction and a column direction of the matrix, the number of central pixel electrodes 135a of each column is increased (or decreased) one by one in accordance with the inclination of the side.

The peripheral pixel electrodes 135b are provided so as to protrude from the central region 130A of the first substrate 130 to the peripheral region 130B. The peripheral pixel electrodes extend so as to be perpendicular to the sides of the central region 130A. The corner pixel electrodes 135c are arranged in the corners of the octagon and are provided so as to protrude from the central region 130A of the first substrate 130 to the peripheral region 130B. The corner pixel electrodes are provided so as to fill gaps between the peripheral pixel electrodes 135b in the corners. For example, a segment driving circuit may be separately provided so as to be connected to the corner pixel electrodes 135c.

As the present embodiment, even in a case where the display device 105 (the first substrate 130) has the shape (for example, the octagonal shape) different from the rectangular shape, it is possible to widen the display region. Accordingly, similar to the first embodiment, it is possible to obtain an active matrix circuit substrate which has a wider display region and in which the design of a driving system is not complicated while maintaining a high freedom degree of display.

The configuration of the present embodiment is not limited to the above-described configuration. For example, as shown in FIG. 10, in the side inclined at 45° with respect to the row direction and the column direction of the matrix, the peripheral pixel electrodes 135b may be provided along the positions of the central pixel electrodes 135a as shown in Figure and the corner pixel electrodes 135c may not be provided.

### Third Embodiment

Next, a third embodiment of the invention will be described.

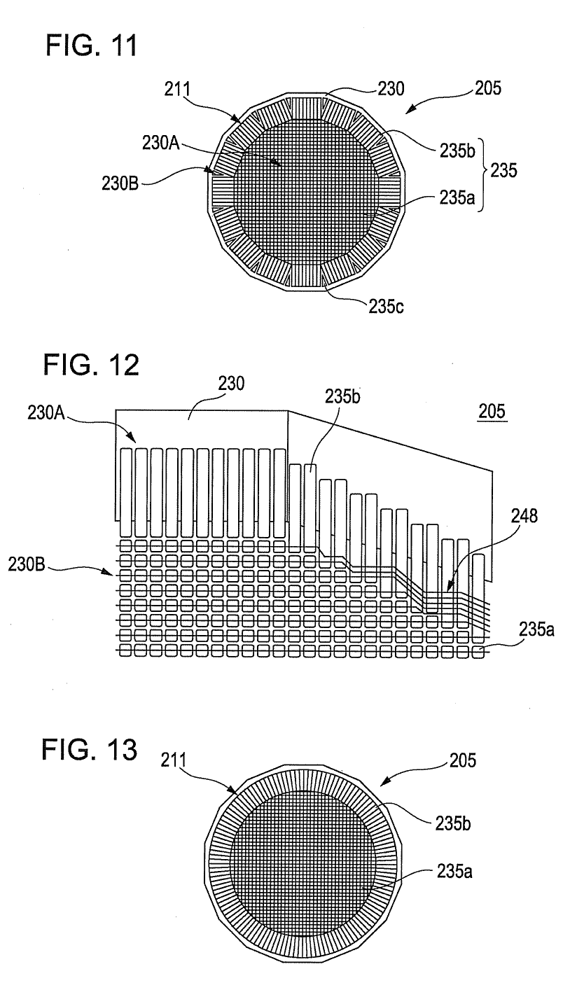

FIG. 11 is a view showing the configuration of a first substrate (active matrix circuit substrate) 230 of a display device 205 according to the present embodiment.

As shown in FIG. 11, the shape of the first substrate 230 of the display device 205 is hexadecon in plan view. A central portion of the first substrate 230 is a region (a central region 230A) in which pixels are arranged in a matrix. A peripheral portion of the first substrate 230 is, for example, a region (a peripheral region 230B) in which driver circuits are formed.

Central pixel electrodes 235a are arranged in the central region 230A of the first substrate 230 in a matrix, peripheral pixel electrodes 235b are provided so as to protrude from the central region 230A to the peripheral region 230B, and central pixel electrodes 235c are provided so as to fill gaps between the peripheral pixel electrodes 235b in the corners of the central region 230A. The peripheral pixel electrodes 235b are provided across the scan lines 248. Similar to the second embodiment, for example, a segment driving circuit may be separately provided so as to be connected to the corner pixel electrodes 235c.

As the present embodiment, even in a case where the shape of the display device 205 (the first substrate 230) is hexadecon, it is possible to widen the display region. Accordingly, similar to the first embodiment, it is possible to obtain an active matrix circuit substrate which has a wider display region and in which the design of a driving system is not complicated while maintaining a high freedom degree of display.

The configuration of the present embodiment is not limited to the above-described configuration. For example, as shown in FIG. 12, in a side inclined at 22.5° with respect to the row direction and the column direction of the matrix, the peripheral pixel electrodes 235b may be shifted in the column direction as shown in Figure such that the corner pixel electrodes 235c may not be provided. For example, as shown in FIG. 12, the peripheral pixel electrodes 235b are shifted in the column direction (the extension direction of the peripheral pixel electrodes 235b) and the scan lines 248 are tied stepwise as shown in the drawing (in the same drawing, up to six scan lines are tied stepwise from an upper direction). When the scan lines 248 are tied stepwise, the peripheral pixel electrodes 235b may have a shape similar to a circle.

As shown in FIG. 13, the shape of the central region 230A may be a circle. When the central region 230A has a circular shape, the positions of the central pixel electrodes 235a arranged in the central region 230A in the matrix are adjusted. In addition, since the peripheral pixel electrodes 235b are provided across the circumference of the circular central region 230A, it is possible to realize the configuration in which the corner pixel electrodes 235c are not provided.

### Fourth Embodiment

Next, a fourth embodiment of the invention will be described.

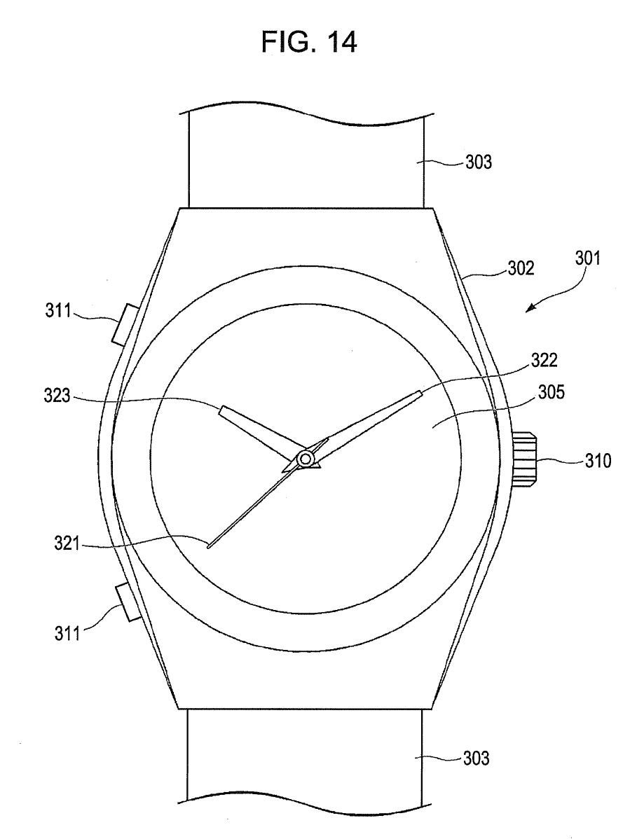

FIG. 14 is a front view of a wristwatch 301 having a display device according to the present embodiment.

As shown in FIG. 14, the wristwatch 301 mainly includes a watch casing 302 and a pair of bands 303 connected to the watch casing 302.

The watch casing 302 is formed of metal such as stainless steel or resin such plastic resin. In a front surface of the watch casing 302, a display device 305, a second hand 321, a minute hand 322 and an hour hand 323 are provided. On the side surface of the watch casing 302, a winder 310 functioning as an operator and an operation button 311 are provided. The winder 310 is connected to a winding stem (not shown) provided in the casing and is integrally provided with the winding stem so as to be rotated, pushed or pulled in multiple steps (for example, two steps).

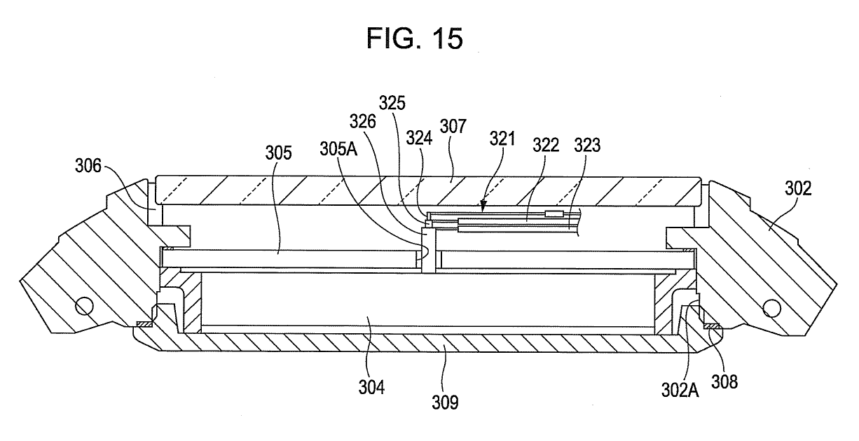

FIG. 15 is a side cross-sectional view of a wristwatch 301.

As shown in FIG. 15, a receiving portion 302A is provided in the watch casing 302. A movement 304 and the display device 305 are received in the receiving portion 302A.

The movement 304 has a needle handling mechanism (not shown) connected with an analog pointer composed of the second hand 321, the minute hand 322 and the hour hand 323. The needle handling mechanism rotates the analog points 321 to 323 so as to function as a time display portion for displaying a time.

The display panel 305 is, for example, an active matrix driving electrophoretic display panel and is positioned at the watch front surface side of the movement 304. The display panel 305 configures a display unit of the wristwatch 301. The display surface of the display panel 305 has a circular shape. The shape of the display surface may be regular octagon, hexadecon, or other shapes, in addition to the circle.

In a central portion of the display panel 305, a penetration hole 305A which penetrates through the front and rear surfaces of the display panel 305 is formed. Shafts of a second wheel 324, a second wheel 325 and a scoop wheel 326 of the needle handling mechanism (not shown) of the movement 304 are inserted into the penetration hole 305A. The second hand 321, the minute hand 322 and the hour hand 323 are attached to the front ends of the shafts, respectively.

A transparent cover 307 made of glass or resin is provided at one end side (watch front surface side) of the receiving portion 302A. The transparent cover 307 is pressed in and fixed to the receiving portion 302A through a press-in ring 306 made of resin or metal. A rear cover 309 is screwed to the other end side (watch rear surface side) of the receiving portion 302A through a packing 308. Sealing performance of the watch casing 302 is ensured by the rear cover 309 and the transparent cover 307.

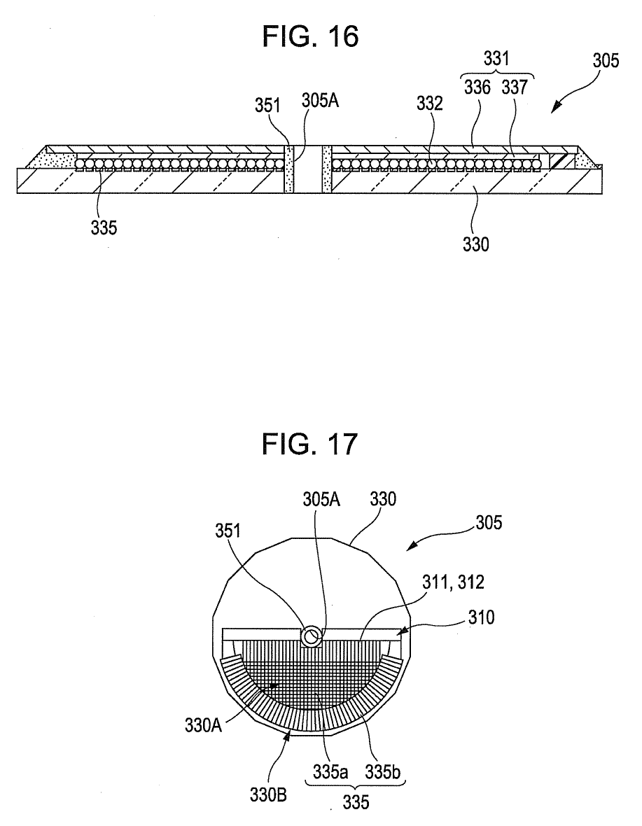

FIG. 16 is a schematic cross-sectional view showing the configuration of the display panel 305.

As shown in FIG. 16, the display panel 305 mainly 9 includes a first substrate (active matrix circuit substrate) 330, a second substrate 331 and an electrophoretic layer 332.

The first substrate 330 and the second substrate 331 face each other with the electrophoretic layer 332 interposed therebetween. On an inner surface (opposite to the second substrate 331) of the first substrate 330, pixel electrodes 335 are formed. On an inner surface (opposite to the first substrate 330) of the second substrate 331, a common electrode (opposing electrode) 337 formed of a transparent conductive material such as ITO is formed. An outer surface of the second substrate 331 becomes a display surface for displaying an image such as a still image or a moving image. The penetration hole 305A is formed in the central portion of the first substrate 330 and the second substrate 331. The penetration hole 305A penetrates through overlapping regions of the first substrate 330 and the second substrate 331 in plan view. A seal portion 351 is formed on the inner side surface of the penetration hole 305A. The seal portion 351 is provided so as to seal a region between the first substrate 330 and the second substrate 331 (a region in which the electrophoretic layer 332 is provided).

FIG. 17 is a plan view showing the configuration of the first substrate 330 of the display panel 305.

The shape of the first substrate 330 is, for example, hexadecon. Portions of the seal portion 351 and the penetration hole 305A are formed in the substantially central portion of the first substrate 330.

Central pixel electrodes 335a are arranged in a matrix in a central portion (a lower central region 330A) of a lower half region on the basis of a portion in which the penetration hole 305A is formed. Driver circuits 311 and 312 and a segment electrode 310 are provided in a peripheral region (a lower peripheral region 330B) of the lower half region.

Peripheral pixel electrodes 335b are provided so as protrude from the lower central region 330A to the lower peripheral region 330B. The peripheral pixel electrodes 335b which are arranged along an arc portion of the lower central region 330A extend along a diameter direction of the arc portion. The peripheral pixel electrodes 335b which are arranged along an upper side of the lower central region 330A in the drawing are arranged so as to partially overlap the driver circuits 311 and 312 in plan view.

The segment electrode 310 is, for example, connected to a segment driving circuit which is separately provided. The segment electrode 310 can be driven by a driving system different from that of the pixel electrodes 335. In an upper half region, a driving system of the pixel electrodes 335 or the driver circuits 311 and 312 is not provided.

As the present embodiment, even in a case where the penetration hole 305A is formed in the central portion of the display panel 305, it is possible to obtain an active matrix circuit substrate which has a wider display region and in which the design of a driving system is not complicated while maintaining a high freedom degree of display.

The technical scope of the invention is not limited to the above-described embodiments and modification may be made without departing from the spirit of the invention.

For example, although, in the above-described embodiments, one pixel driving circuit is connected to one peripheral pixel electrode, the invention is not limited to this. For example, a plurality of pixel driving circuits may be connected to one peripheral pixel electrode. Since the plurality of pixel driving circuits are connected to the peripheral pixel electrode so as to function as a redundancy circuit even when the pixel driving circuit is damaged, it is possible to perform a display with certainty.

Some of the plurality of peripheral pixel electrodes may be ground electrodes. By this configuration, a constant voltage is always applied between the peripheral pixel electrodes and the opposing electrodes. If the peripheral pixel electrodes are formed of metal, an electrical resistance value is decreased and thus the peripheral pixel electrodes are used as reinforcement members of other wires. Since the other wires are reinforced by the peripheral pixel electrodes, the other wires can be thinly formed.

What is claimed is:

1. An active matrix circuit substrate comprising:
a substrate on which a plurality of pixels are formed in a predetermined region;
a plurality of pixel electrodes which are respectively provided in the pixels formed on the substrate and include peripheral pixel electrodes which protrude from the predetermined region to an outer region of the predetermined region; and
pixel driving circuits which are provided in the predetermined region of the substrate in correspondence with the pixel electrodes and supply driving signals to the pixel electrodes.

2. The active matrix circuit substrate according to claim 1, further comprising a driver circuit which is provided in the outer region of the predetermined region of the substrate and supplies electrical signals to the pixel driving circuits,
wherein portions of the peripheral pixel electrodes overlap the driver circuit in plan view.

3. The active matrix circuit substrate according to claim 1, wherein the area of each of the peripheral pixel electrodes is larger than that of each of the pixel electrodes provided in the predetermined region.

4. The active matrix circuit substrate according to claim 3, wherein the pixel driving circuits supply the driving signals each having an intensity according to the area of each of the pixel electrodes.

5. The active matrix circuit substrate according to claim 1, wherein the plurality of pixel driving circuits are provided in each of the peripheral pixel electrodes.

6. The active matrix circuit substrate according to claim 1, wherein the plurality of peripheral pixel electrodes are provided and some of the plurality of peripheral pixel electrodes are ground electrodes.

7. The active matrix circuit substrate according to claim 1, wherein the plurality of peripheral pixel electrodes are provided and some of the plurality of peripheral pixel electrodes are segment driving electrodes.

8. The active matrix circuit substrate according to claim 7, wherein a driving circuit for independently driving the segment driving electrodes is provided.

9. A display device comprising:
first and second substrates which face each other with an electrophoretic material layer interposed therebetween;
pixel electrodes which are formed on a surface of the first substrate opposite to the second substrate; and
opposing electrodes which are formed on a surface of the second substrate opposite to the first substrate,
wherein the first substrate is the active matrix circuit substrate according to claim 1.

10. The display device according to claim 9, wherein the electrophoretic material is an electrophoretic dispersion which is composed of electrophoretic particles and a liquid phase dispersion medium which disperses the electrophoretic particles.
